(19) United States
(12) Patent Application Publication
(10) Pub. No.: US 2015/0062651 A1
(43) Pub. Date: Mar. 5, 2015

(54) PRINTING APPARATUS, PRINTING CONTROL APPARATUS, METHOD OF CONTROLLING PRINTING APPARATUS, AND STORAGE MEDIUM

(71) Applicant: Canon Kabushiki Kaisha, Tokyo (JP)

(72) Inventor: Takaaki Yano, Tokyo (JP)

(21) Appl. No.: 14/472,203

(22) Filed: Aug. 28, 2014

(30) Foreign Application Priority Data
Sep. 5, 2013 (JP) 2013-184056

(51) Int. Cl. G06K 15/00

(52) U.S. Cl. CPC G06K 15/4065
USPC 358/1.18

(57) ABSTRACT

A printing apparatus includes a storing unit, an obtaining unit, a determining unit, and a setting unit. The storing unit stores property information and a size of a sheet used in image adjustment printing, and also stores property information and a size of a sheet not used in image adjustment printing. The obtaining unit obtains a size of a held sheet. The setting unit sets sheet property information such that when the determining unit determines that the printing apparatus is in the state in which it is allowed to perform the image adjustment printing, the setting unit reads out, from the storing unit, the property information of the sheet that is used in the printing for the image adjustment and that has a size consistent with the size obtained by the obtaining unit, and the setting unit sets the read property information as property information of the held sheet.

### BACKGROUND OF THE INVENTION

1. Field of the Invention

The present invention relates to a printing apparatus capable of effectively using property information of a sheet held in a sheet holding unit of a printing apparatus, a printing control apparatus, a method of controlling a printing apparatus, and a storage medium.

2. Description of the Related Art

In related techniques, in a case where printing is performed using a printing apparatus having a sheet holding unit, it is commonly performed to set in advance sheet property information so as to be related to the sheet holding unit in terms of, for example, a name of a sheet, a size of the sheet, a basis weight of the sheet, a surface property of the sheet, a color of the sheet, and/or the like. To save sheet property information so as to be related to the sheet holding unit, it is necessary to input sheet property information individually for each sheet holding unit each time the setting is performed, which may need a troublesome operation. To handle the above situation, it is known to register in advance property information of each sheet in a sheet management database such that a user is allowed to select desired property information of a sheet from the sheet management database and save the selected sheet property information so as to be related to a particular sheet holding unit (Japanese Patent Laid-Open No. 2007-241425).

In the technique disclosed in Japanese Patent Laid-Open No. 2007-241425, in a case where a large number of sheets are registered in the sheet management database, it takes a long time for a user to perform a troublesome operation to find a particular sheet from the large number of sheets registered. A user may want to select a sheet depending on various situations such as a situation in which printing is performed in a normal mode, a situation in which printing for image adjustment is performed, or the like. In such situations, it may be necessary for the user to perform a troublesome operation to find property information for a particular sheet holding unit from the sheet management database.

### SUMMARY OF THE INVENTION

According to an aspect of the present invention, a printing apparatus includes a storing unit configured to store a size of a sheet used in printing for image adjustment by a printing unit of the printing apparatus and property information of the sheet, and also store a size of a sheet not used in printing for image adjustment by the printing unit and property information of the sheet not used in printing, an obtaining unit configured to obtain a size of a sheet held in a sheet holding unit, a determining unit configured to determine whether the printing apparatus is in a state in which it is allowed to perform the printing for the image adjustment by the printing unit, and a setting unit configured to set sheet property information such that, in a case where the determining unit determines that the printing apparatus is in the state in which it is allowed to perform the printing for the image adjustment, the setting unit reads out, from the storing unit, the property information of the sheet that is used in the printing for the image adjustment and that has a size consistent with the size obtained by the obtaining unit, and the setting unit sets the read property information as property information of the sheet held in the sheet holding unit.

Further features of the present invention will become apparent from the following description of exemplary embodiments with reference to the attached drawings.

### BRIEF DESCRIPTION OF THE DRAWINGS

FIG. 1 is a diagram illustrating a printing system according to a first embodiment.

FIG. 2 is a block diagram illustrating a configuration of a server according to the first embodiment.

FIG. 3 is a block diagram illustrating a configuration of a printing apparatus according to the first embodiment.

FIG. 4 is a diagram illustrating data stored in a hard disk drive (HDD) unit of a server according to the first embodiment.

FIGS. 5A and 5B are diagrams respectively illustrating an example of a calibration management screen and an example of a calibration setting screen displayed on a server according to the first embodiment.

FIGS. 6A, 6B, and 6C are diagrams respectively illustrating examples of a profile edit screen, a test page print screen, and a spot color edit screen displayed on a server according to the first embodiment.

FIG. 7 is a flow chart illustrating a process performed by a server to register sheet information in a sheet information storage unit according to the first embodiment.

FIG. 8 is a diagram illustrating an example of a registration screen indicating sheet information registered in a sheet information storage unit of a server according to the first embodiment.

FIG. 9 is a flow chart illustrating a process performed by a server to register sheet information individually for each sheet feeding unit in a sheet feeding unit information storage unit according to the first embodiment.

FIG. 10 is a diagram illustrating an example of a registration screen displayed on a server to indicate sheet information registered in a sheet feeding unit information storage unit individually for each sheet feeding unit according to the first embodiment.

FIG. 11 is a flow chart illustrating a process performed by a printing apparatus to set property information of a particular sheet so as to be related to a sheet feeding unit according to the first embodiment.

FIG. 12 is a flow chart illustrating a process performed by a server to search for a sheet registered in a sheet feeding unit information storage unit according to the first embodiment.

FIG. 13 is a diagram illustrating an example of a warning screen displayed on an operation unit of a printing apparatus according to the first embodiment.

### DESCRIPTION OF THE EMBODIMENTS

Embodiments of the invention are described in detail below with reference to accompanying drawings. Note that the purpose of the embodiments described above is not to limit the invention. Also note that all parts, elements, or steps described in embodiments are not necessarily needed to practice the invention.

### First Embodiment

### Printing System

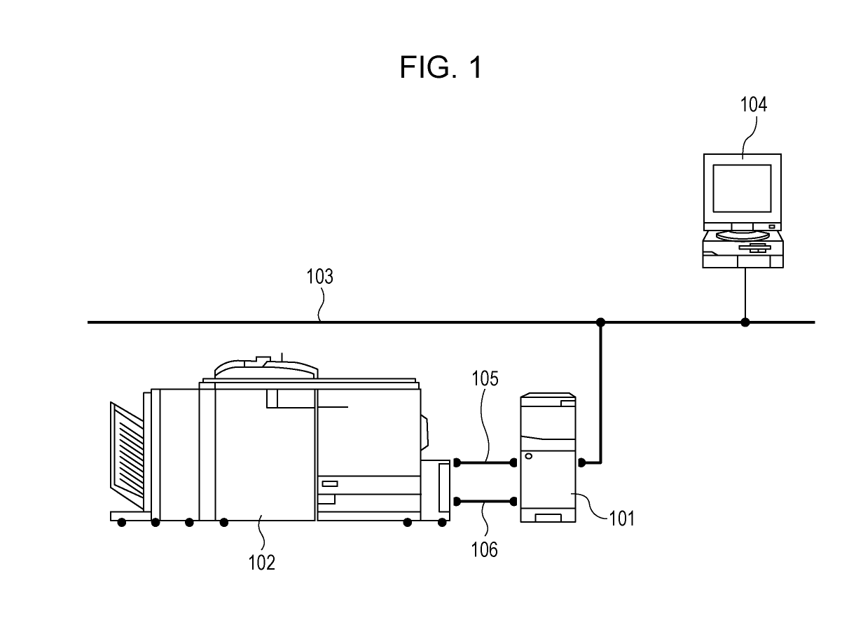

Referring to FIG. 1, a printing system according to a first embodiment of the invention is described below.

A printing apparatus (printer) 102 has various functions including scanning, printing, copying, and/or the like. A server 101 has various functions including image processing, print controlling, job managing, and/or the like. An information processing apparatus (computer or the like) 104 has functions including editing an application file, instructing printing, and/or the like.

In this printing system, the printing apparatus 102 and the server 101 are connected to each other via a network 105, and a video cable 106. Furthermore, the server 101 and the information processing apparatus 104 are connected to each other via a network 103 such as a LAN, a WAN, or the like or a wireless LAN such that they are allowed to communicate with each other. The video cable 106 is used to transfer a print image, and the network 105 is used to transmit/receive other kinds of information. In the following description, the network used to connect the printing apparatus 102 and the server 101 may be a LAN, a WAN, or the like unless otherwise specified and as long as functions of the invention are realized.

Note that following descriptions of the embodiments are given by way of example for a case where the information processing apparatus 104 does not transmit or receive data or commands directly to or from the printing apparatus 102. In the present embodiment, the information processing apparatus 104 transmits and receives various kinds of data to or from the printing apparatus 102 via the server 101. The server 101 transfers a print job received from the information processing apparatus 104 connected to the server 101 to the printing apparatus 102. A user is allowed to check a status of a job or a status of the server 101 or the printing apparatus 102 by using the information processing apparatus 104. A user is allowed to directly or remotely operate the server 101 to save sheet property information in, for example, the printing apparatus 102 such that the sheet property information is related to a sheet feeding unit (a sheet holding unit) of the printing apparatus 102.

In a case where the information processing apparatus 104 also plays a role as a server instead of the server 101, the information processing apparatus 104 may transmit/receive data or a command directly to/from the printing apparatus 102. In this case, the information processing apparatus 104 may be configured in a similar manner to the server 101 except that the information processing apparatus 104 is connected to the printing apparatus 102 via the network 105 and the video cable 106.

### Configuration of Server

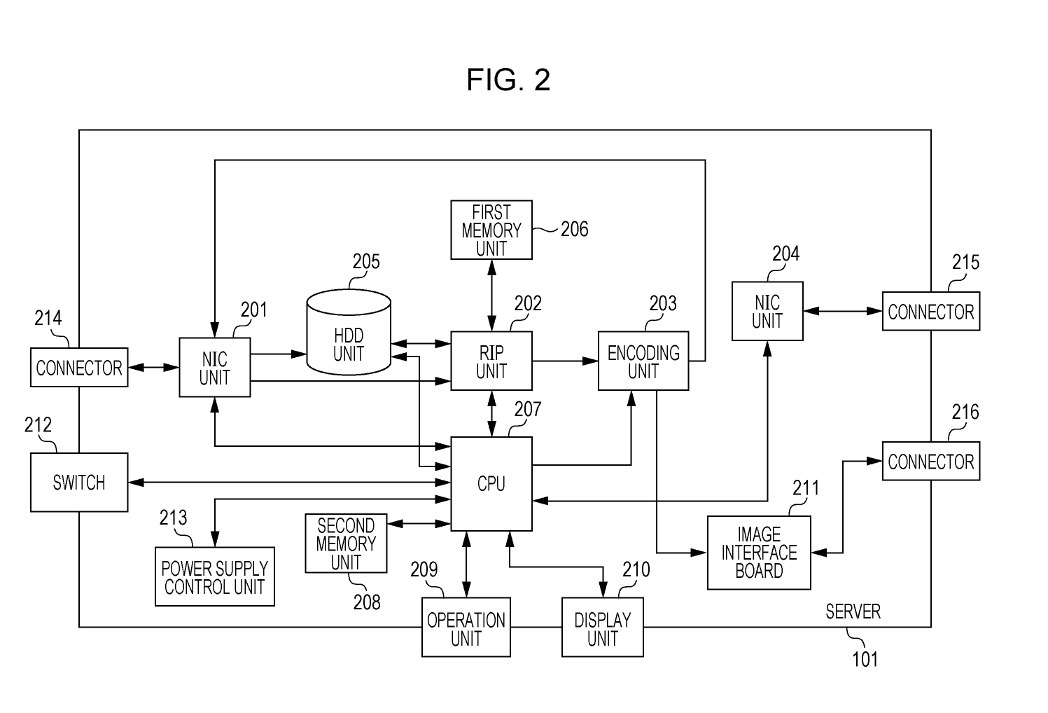

An example of a configuration of the server 101 according to the first embodiment of the invention is described below with reference to FIG. 2.

A network interface card (NIC) 201 functions as a first network interface providing an interface between the network 103 and lower layer levels. On the other hand, a NIC 204 functions as a second network interface providing an interface with lower layer levels.

A raster image processor (RIP) unit 202 performs a process to convert data represented in a printing language such as a page description language (PDL) or other particular data formats into a raster image.

An encoding unit 203 performs a process to convert raster image data into print data in a format supported by the printing apparatus 102 or in other data formats.

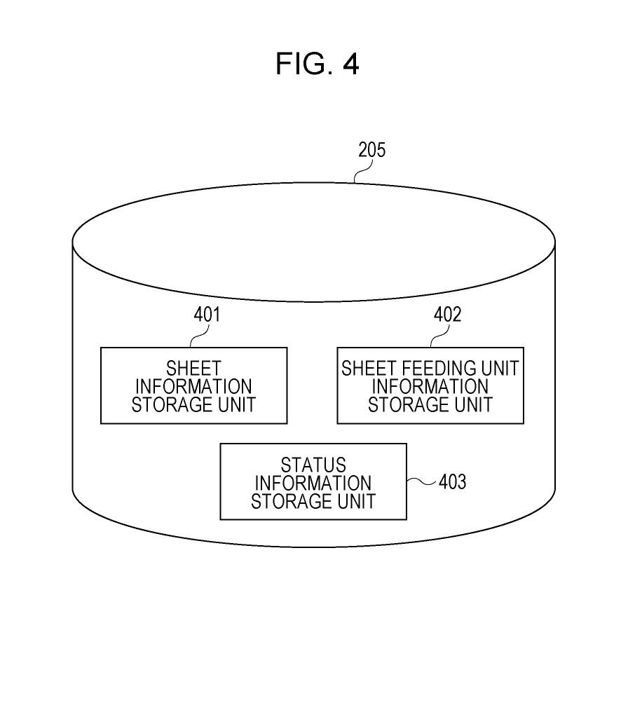

A hard disk drive (HDD) unit 205 temporarily stores (spools) print data received via the NIC unit 201 or temporarily stores compressed data after being subjected to the RIP process. In the HDD unit 205, a sheet information storage unit 401 and a sheet feeding unit information storage unit 402 are allocated and data is stored therein as described later with reference to FIG. 4. In addition to data stored in the sheet information storage unit 401 and the sheet feeding unit information storage unit 402, system software used in various processes described below are also stored in the HDD unit 205. The data stored in the sheet information storage unit 401 and the data stored in the sheet feeding unit information storage unit 402 may be stored in a nonvolatile memory such as a solid state drive (SSD) instead of the HDD unit 205.

A central processing unit (CPU) 207 controls processes or operations performed by various units in the server 101. A first memory unit 206 is used in an image format conversion process performed by the RIP processing unit 202. On the other hand, a second memory unit 208 is used by the CPU 207 as a temporary data storage area.

An operation unit 209 includes a button, a key, a touch panel, and/or the like, and is used to operate the server 101. A display unit 210 performs a process to provide information to a user using an image or a character. An image interface board 211 and a connector 216 for the image interface board 211 are used in producing image data and transferring the resultant image data to a dedicated transmission line. A switch 212 is operated by a user to turn on/off electric power. When the switch 212 is operated, an interrupt to the CPU 207 occurs. Upon detecting the interrupt, the CPU 207 controls a power supply control unit 213 depending on a state.

A data packet from the information processing apparatus 104 to the server 101 is transmitted via the network 103 and is received by the server 101 via a connector 214. In the server 101, the NIC unit 201 performs reception processing on data. In a case where print data is received, under the control of the CPU 207, the received data is stored into the HDD unit 205 as necessary. The storing of data into the HDD unit 205 is generally performed to enhance a data transfer speed. This technique is generally known as cueing (spooling). The data stored in the HDD unit 205 is read out by the RIP processing unit 202 under the control of the CPU 207.

Subsequently, based on preset data formats interpretable by the printing apparatus 102 and the data format of the received data, the encoding unit 203 functioning as the data format conversion unit encodes the data into a data format interpretable by the printing apparatus 102. It is required that the encoded data has a data format interpretable by the printing apparatus 102.

The data format may vary depending on an ability of an interpretation unit possessed by the printing apparatus 102. An example of a data format is a particular printing language format or a compressed data format as JBIG or the like. The resultant data encoded in the above-described manner is again converted by the NIC unit 204 into a data packet for transmission to the network 105 and is transmitted from the connector 215 to the printing apparatus 102 via the network 105. Alternatively, the encoded data may be transmitted to the printing apparatus 102 via a local interface such as a universal serial bus (USB).

Upon receiving the data packet, the printing apparatus 102 performs printing on a recording medium such as a sheet according to a printing procedure defined in the printing apparatus 102.

Another method of transferring data is to transfer the data to the image interface board 211 via the encoding unit 203 and further transmit the data from the connector 216 to the printing apparatus 102 via the video cable 106. In the transmission of data packets, the information processing apparatus 104 acquires, as necessary, information indicating a power status of the server 101 and the printing apparatus 102 and/or information indicating whether they are in a normal state, and, depending on the acquired information, the information processing apparatus 104 transmits data packet to the server 101. The information processing apparatus 104 performs polling at regular time intervals to detect the power supply state and the operation state of the server 101 and the printing apparatus 102 thereby acquiring a state change notification packet transmitted from the server 101 or the printing apparatus 102. Based on the acquired state change notification packet, the information processing apparatus 104 changes the processing performed. For example, in a case where the information processing apparatus 104 receives a power supply state notification packet indicating turning-off of the power of the printing apparatus 102, the information processing apparatus 104 stops the polling, which makes it possible to prevent unnecessary traffic from occurring on the network.

### Configuration of Printing Apparatus

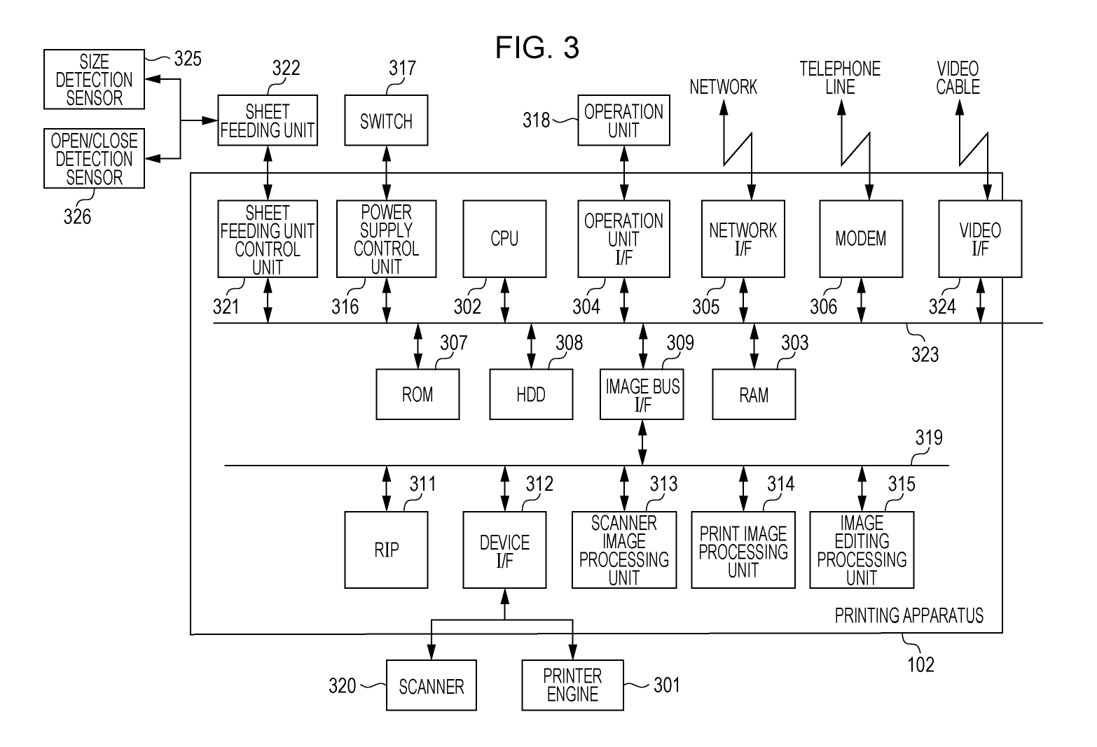

Referring to FIG. 3, an example of a configuration of the printing apparatus 102 according to the first embodiment of the invention is described below.

The printing apparatus 102 includes a plurality of sheet feeding units (sheet holding units) 322. The sheet feeding units may be sheet feed trays or manual sheet feed trays or a combination of sheet feed trays and manual sheet feed trays. Each sheet feeding unit (sheet holding unit) 322 includes a size detection sensor 325 configured to detect the size of a sheet held on the sheet feeding unit (sheet holding unit), an open/close detection sensor 326 configured to detect an operation of opening/closing the sheet feeding unit, and the like. Each sheet feeding unit (sheet holding unit) 322 may further include a sensor for detecting the remaining number of sheets on the sheet feeding unit (sheet holding unit) 322, a sensor for detecting a color or a surface property of a sheet held on the sheet feeding unit (sheet holding unit) 322, and/or the like.

The printing apparatus 102 is connected to a scanner 320 functioning as an image input device and a printer engine 301 functioning as an image output device thereby controlling reading or printing of image data. The printing apparatus 102 may be connected to a network, a telephone line, a video cable, or the like to make it possible to input/output image information or device information via the network or the video cable.

The CPU 302 is a central processing unit that controls the whole printing apparatus 102. A RAM 303 is a system work memory used in an operation by the CPU 302. The RAM 303 is also used as an image memory for temporarily storing input image data. A ROM 307 is a boot ROM in which a system boot program is stored. The HDD 308 is a hard disk drive for storing system software used in various kinds of processing described below. The HDD 308 is also used to store input image data and the like.

An operation unit I/F 304 is a unit providing an interface with an operation unit 318 including a display screen capable of displaying image data or the like, and the operation unit I/F 304 is configured to output operation screen data to the operation unit 318. The operation unit I/F 304 also serves to transfer information input by a user via the operation unit 318 to the CPU 302. The operation unit 318 includes a touch panel unit and a key input unit, which are not illustrated in the figure. The operation unit 318 provides various kinds of interfaces in performing setting or operations, by a user, on the printing apparatus 102 according to the first embodiment.

A network I/F 305 realized, for example, by a LAN card or the like is connected to a network to input/output information from/to an external apparatus. A modem 306 is connected to a telephone line to input/output information from/to an external apparatus. A video I/F 324 is connected to a video cable to input/output information from/to an external apparatus.

Note that the units described above are disposed on a system bus 323.

An image bus I/F 309 is an interface for connecting the system bus 323 to an image bus 319 for transferring image data at a high speed, and the image bus I/F 309 provides a function of a bus bridge to convert a data structure. A raster image processor (RIP) 311, a device I/F 312, a scanner image processing unit 313, a printer image processing unit 314, and an image editing processing unit 315 are disposed on the image bus 319.

The RIP 311 is a raster image processor that converts data expressed in a page description language (PDL) into a raster image. The device I/F 312 performs a synchronous/asynchronous conversion on image data sent/received to/from the scanner 320 or the printer engine 301. The scanner image processing unit 313 performs various processes such as a correction process on image data input from the scanner 320. The printer image processing unit 314 performs processes such as a correction process and a resolution conversion process depending on the printer engine and/or the like on image data to be printed. The image editing processing unit 315 performs various kinds of image processing such as rotation, compression/expansion, and/or the like, on image data.

A switch 317 is operated by a user to turn on/off electric power. When the switch 317 is operated, a power supply control unit 316 issues an interrupt to the CPU 302. Upon detecting the interrupt, the CPU 302 controls the power supply control unit 316 depending on a state.

A sheet feeding unit control unit 321 is a module configured to store sheet property information so as to be related to the sheet feeding unit 322 and control a sheet feeding operation. Furthermore, the sheet feeding unit control unit 321 stores setting information given from the operation unit 318, setting information received from the server 101, and sheet property information detected for the sheet feeding unit 322. The printing apparatus 102 controls printing based on the stored sheet property information related to the sheet feeding unit. The sheet property information may include, for example, information indicating a size, a basis weight, a color, a surface property, and/or the like, of a sheet.

For example, based on a size of a sheet used in a print job to be performed, the printing apparatus 102 determines a sheet feeding unit 322 from which to feed the sheet, and controls the operation such that the sheet is fed from the determined sheet feeding unit 322. Furthermore, the printing apparatus 102 controls a sheet conveying speed and temperature of a fixing unit based on the basis weight and the surface property of the sheet. The sheet feeding unit control unit 321 acquires information associated with the open/close operation of the sheet feeding unit 322 from the open/close detection sensor 326 to detect whether the sheet feeding unit 322 is closed from an open state.

In the present embodiment, the sheet information storage unit 401, the sheet feeding unit information storage unit 402, and the status information storage unit 403 are realized in storage areas allocated in the HDD unit 205 of the server 101 as illustrated in FIG. 4. Alternatively, the sheet information storage unit 401, the sheet feeding unit information storage unit 402, and the status information storage unit 403 may be realized in storage areas in the HDD 308 of the printing apparatus 102. Still alternatively, the sheet information storage unit 401, the sheet feeding unit information storage unit 402, and the status information storage unit 403 may be realized in storage areas of a not-illustrated nonvolatile memory in the information processing apparatus 104. In this case, data stored in the sheet information storage unit 401, the sheet feeding unit information storage unit 402, and the status information storage unit 403 may be accessed via the network 103.

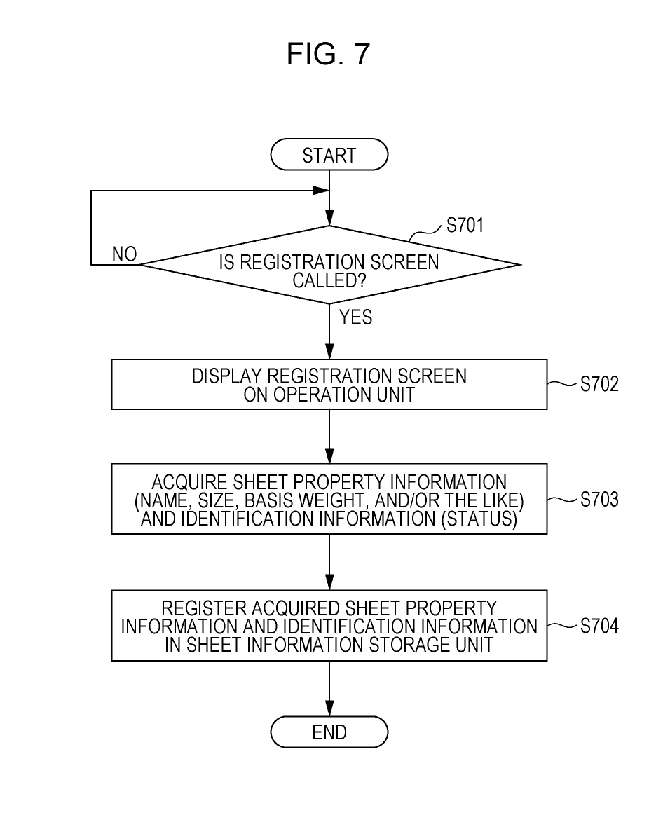

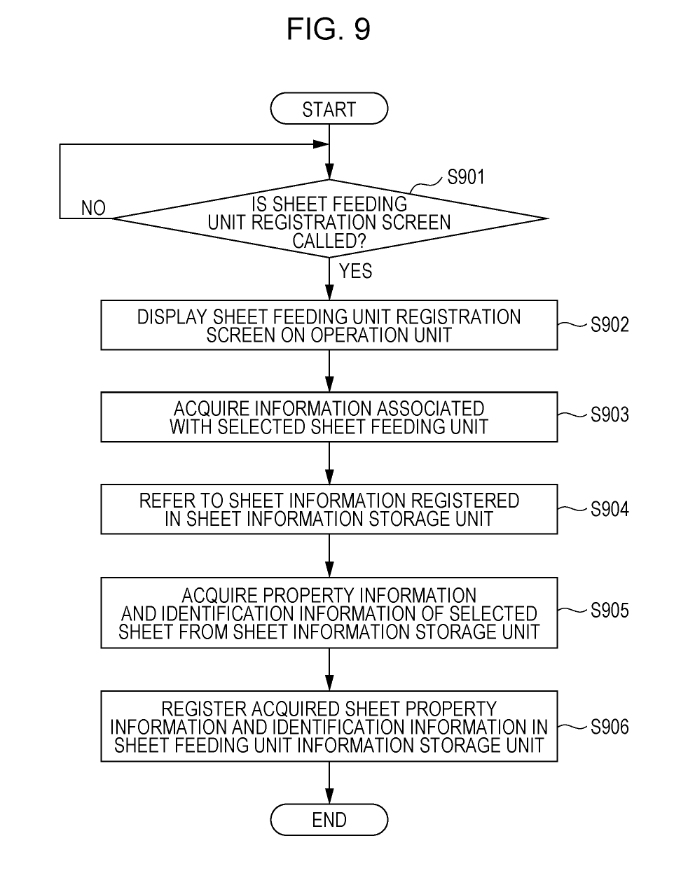

The sheet information storage unit 401 stores property information and identification information in the form of a list for all sheets registered by a user (FIG. 9). The sheet property information registered in the sheet information storage unit 401 includes, for example, a name, a size, a basis weight, and a surface property of the sheet. The sheet identification information is, for example, information indicating whether a sheet of interest is for printing for image adjustment. The sheet identification information corresponds to a status described below. A process of registering sheet information in the sheet information storage unit 401 will be described later with reference to FIG. 7.

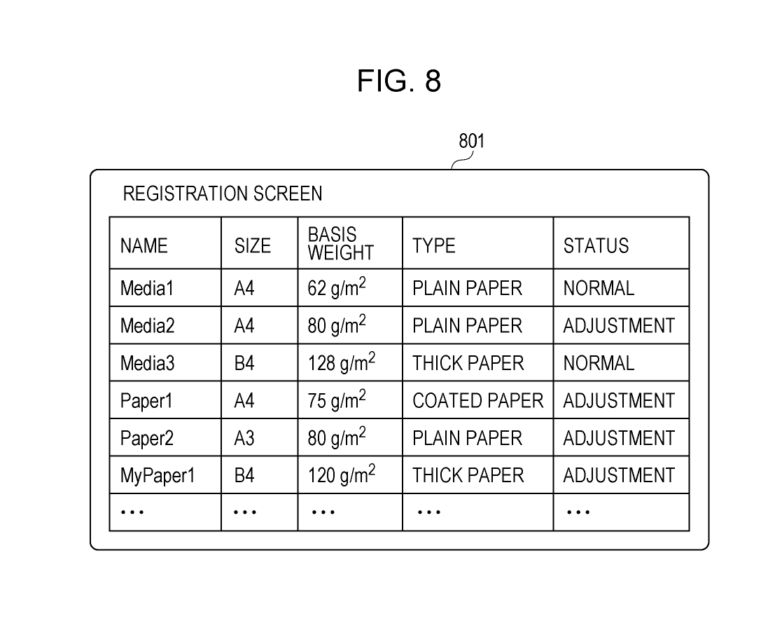

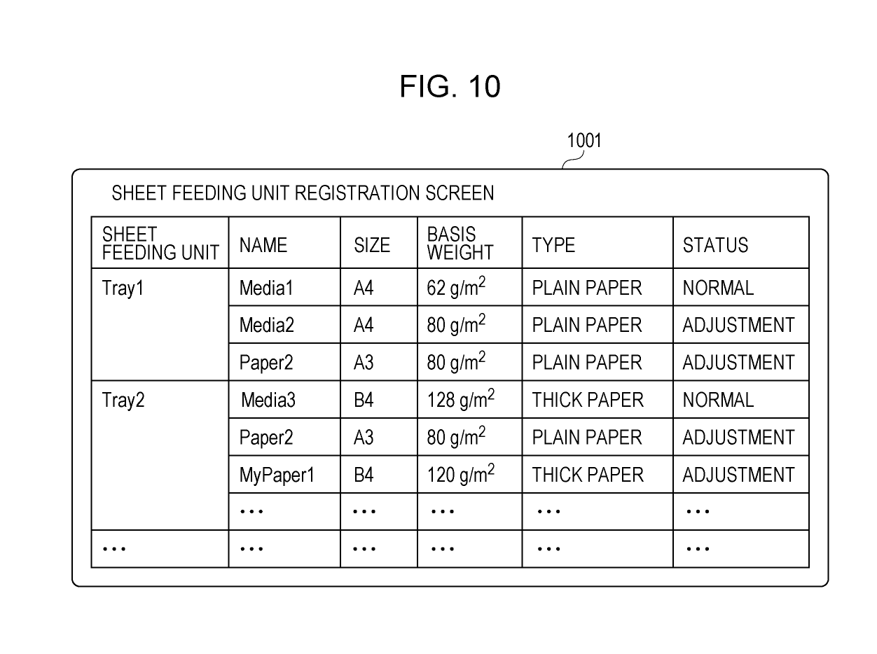

On the other hand, in the sheet feeding unit information storage unit 402, sheet property information and identification information associated with each sheet feeding unit are stored in the form of a list such that a particular sheet is selected by a user from all sheets stored in the sheet information storage unit 401 and the selected particular sheet is stored so as to be related to a particular sheet feeding unit (see FIG. 10). A process of registering sheet information in relation to each sheet feeding unit in the sheet feeding unit information storage unit 402 will be described later with reference to FIG. 8.

The status information storage unit 403 stores information indicating the status of the server 101 monitored by the CPU 207. Note that the information indicating the status is updated as necessary such that the information indicates the current status. In the present embodiment of the invention, the status refers to a state of a screen which is displayed, for accepting an operation by a user, on the operation unit 209 of the server 101. This screen may be a server application screen displayed on a not-illustrated operation unit included in the information processing apparatus 104. Alternatively, the status in the present embodiment may be a status of a screen for accepting an operation by a user displayed on the operation unit 318 of the printing apparatus 102 or a status of a remaining amount of toner used in printing. The status may be defined so as to make it possible to handle a situation in which it is necessary to select a proper sheet from a plurality of sheets depending on whether normal printing is performed or printing is performed for image adjustment or the like.

In the following description, it is assumed by way of example that the status is information indicating the state of the screen displayed on the operation unit 209 of the server 101, that is, the status is in either a “normal” state or an “adjustment” state. When the status of the screen displayed is in the “adjustment” state, the displayed screen is in a state for use in performing image adjustment printing by the server 101 or the printing apparatus 102, or in a state in which a print execution screen is displayed for use in printing an adjustment test chart or a sample chart for use in checking of image adjustment printing by the printing apparatus 102. On the other hand, in the case where the status is in the “normal” state, the screen displayed is in a state functioning as a basic screen used in operating the server 101 or functioning as a print setting screen for accepting various settings of a print job. Functions associated with image adjustment printing include, for example, a calibration function for correcting an output density of the printing apparatus 102, a spot color edit function for editing an output profile for color management of a print job.

First, the calibration function is described in detail below. The calibration process is a process of correcting a density level characteristic of toner used in printing. Using known amounts of toner, a plurality of patches are printed on a sheet for which to make a calibration such that density levels are different among the patches, and resultant density levels are measured using the scanner 320 of the printing apparatus 102 or using a device connected to the server 101 and capable of measuring density levels.

The server 101 has information stored in the HDD unit 205 in terms of a known target density level characteristic. When the calibration is performed, a look-up table (LUT) is generated for use in converting density levels measured in the calibration process into target density levels. When printing is performed, a process is performed to correct the density levels using the generated LUT, which makes it possible to achieve output levels corresponding to the target density levels. Note that the target density levels vary depending on the characteristic of the sheet used in printing because a manner in which toner is applied to a sheet surface varies depending on a difference in basis weight or surface property of the sheet, which results in a change in reflectivity of light in areas in which the toner is applied and thus results in a change in reading density level. In particular, there is a large difference in surface property between plain paper and coated paper, and thus it is beneficial to have information associated with target density levels for each sheet. Hereinafter, an expression “calibration set” is used to denote a set of information of a sheet on which a patch is to be printed for calibration and information indicating target density levels for this sheet.

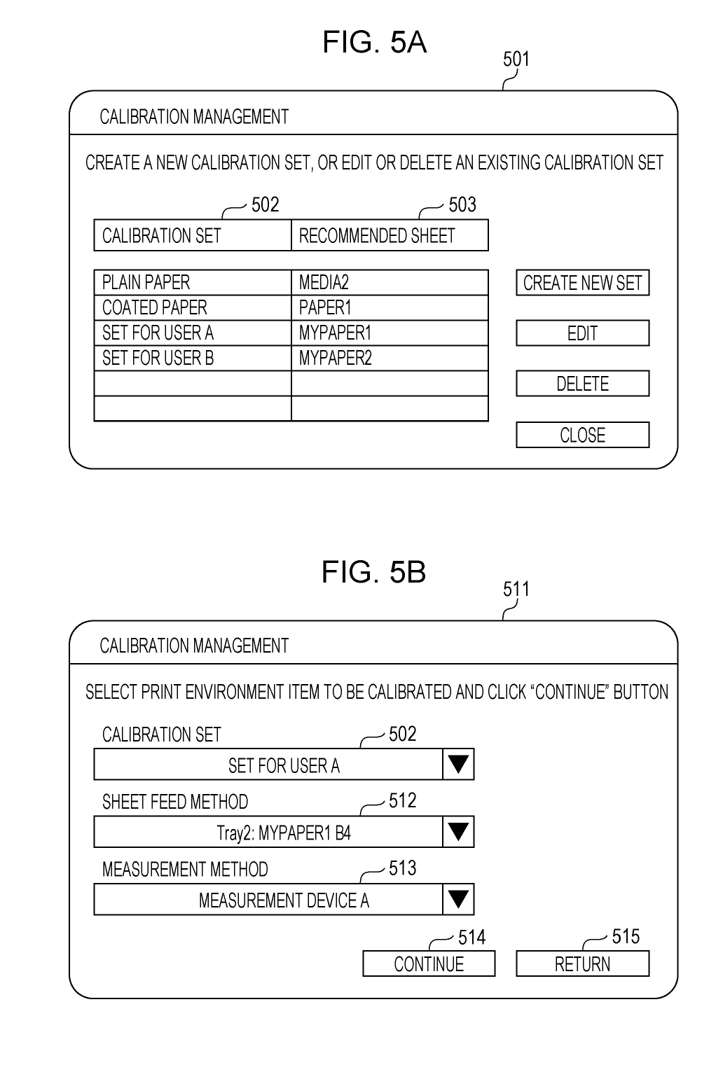

FIG. 5A illustrates a management screen 501 displayed on the operation unit 209 of the server 101. On the management screen 501, information is displayed as to the calibration set 502 managed by the server 101. The calibration set 502 is stored in the HDD unit 205 of the server 101, and is read out by the CPU 207 and used when the calibration process is performed. A calibration set may be added by a user to the existing calibration set 502. In a case where a calibration set is added by a user, property information of a recommended sheet 503 for this calibration set is acquired and stored in the HDD unit 205. A calibration set may be deleted by a user from the calibration sets 502. When a calibration set is deleted by a user, property information of the recommended sheet 503 corresponding to this calibration set is also deleted from the HDD unit 205.

FIG. 5B illustrates a setting screen 511 displayed on the operation unit 209 of the server 101. On the setting screen 511, it is allowed to perform setting for the calibration. More specifically, a user is allowed to input information via the setting screen 511 as to a printing environment for the calibration in terms of the calibration set 502 stored in the HDD unit 205, a sheet feeding method 512, and a measurement method 513. Examples employable as the measurement method 513 include a method using the scanner 320 of the printing apparatus 102, a method using a not-illustrated device which is connected to the server 101 and which is capable of measuring the density.

When a continue button 514 is pressed, patch image data for use in the calibration is generated and is transmitted as a print job to the printing apparatus 102. Thereafter, to make it possible to continue the calibration process according to the content of the setting performed via the calibration setting screen 511, a not-illustrated execution screen is displayed on the operation unit 209 of the server 101.

On the execution screen, a sequence of steps in the calibration procedure is presented according to conditions set via the setting screen 511. The density of a printed patch is then measured using the method selected as the measurement method 513, and a LUT for use in making a correction to achieve the target density levels is generated and is stored in the HDD unit 205. When the calibration process is completed, the execution screen is closed.

In the calibration function, when the screen of the operation unit 209 of the server 101 is in a state in which the setting screen 511 is displayed, the CPU 207 determines that the server 101 is in the status of “adjustment” and stores the status in the status information storage unit 403.

Although in the example described above, the management screen 501, the setting screen 511, and the not-illustrated execution screen are displayed on the operation unit 209 of the server 101, they may alternatively be displayed on the operation unit 318 of the printing apparatus 102. Still alternatively, the management screen 501, the setting screen 511, and the not-illustrated execution screen may be displayed as sever application screens on an operation unit (not illustrated) of the information processing apparatus 104.

Next, details of the profile editing is described below. Input RGB information or CMYK information is converted into Lab information using a LUT (input profile). Thereafter, the Lab information is converted into RGB information or CMYK information dependent on the server 101 using a LUT (output profile). The profiler editing is a process of adjusting a tone curve with an arbitrary profile to adjust a color tone printed on a sheet.

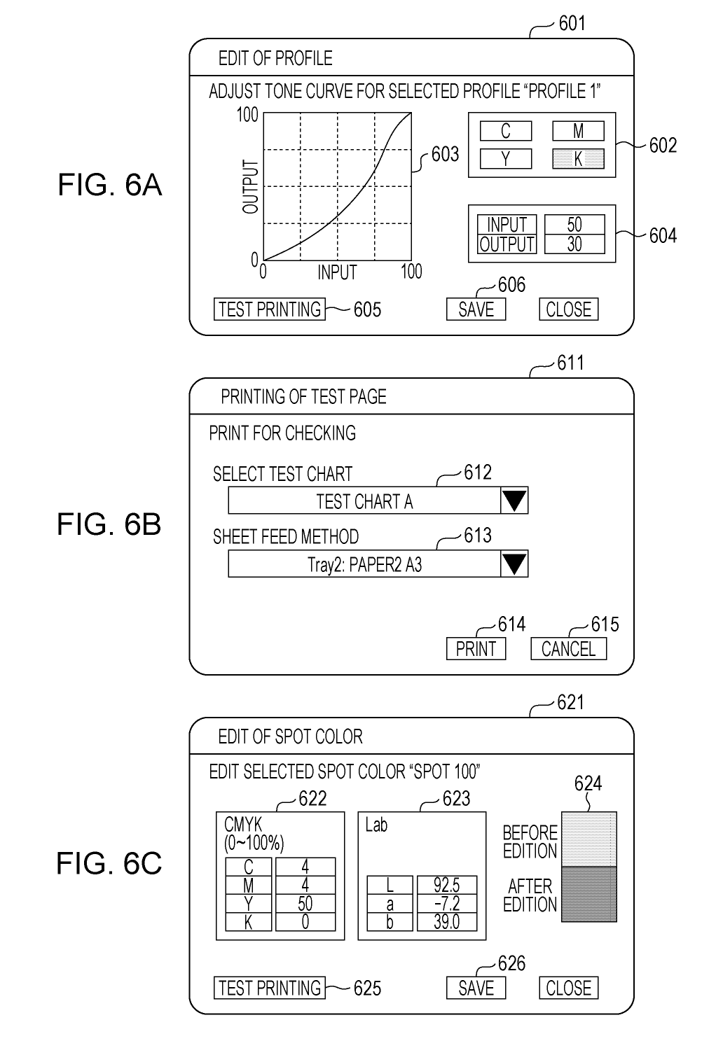

FIG. 6A illustrates an edit screen 601 displayed on the operation unit 209 of the server 101. On the edit screen 601, it is allowed to adjust a tone curve according to an arbitrary profile selected by a user from profiles stored as profile information in the HDD unit 205 of the server 101. For example, a tone curve graph 603 of a color 602 selected by a user from the CMYK information is displayed on the edit screen 601. The tone curve graph 603 is edited according to an input/output value 604 specified by a user, and a result is displayed. After the profile edit process by a user is completed, if a test printing button 605 is pressed, a test page print screen 611 such as that illustrated in FIG. 6B is displayed on the operation unit 209. On the other hand, in a case where a save button 606 is pressed by a user, the edited profile is saved in the HDD unit 205 of the server 101.

Via the print screen 611, it is allowed to print a chart for use in checking a result of the profile editing such that test chart data is generated using the profile edited on the edit screen 601. In a test chart selection box 612, a test chart selected by a user from test charts to be printed is displayed. In a sheet feed method box 613, a sheet feed method selected by a user from sheet feed methods represented by sheet setting information associated with the sheet feeding units 322 of the printing apparatus 102 is displayed. When a print button 614 is pressed by a user, test chart data is generated and transmitted as a print job to the printing apparatus 102. On the other hand, in a case where a cancel button 615 is pressed, the edit screen 601 is re-opened.

Next, details of the spot color editing are described below. Particular CMYK information given as input data is converted into Lab information specified by a spot color. That is, the spot color editing is a process of editing an arbitrary spot color to convert particular CMYK information given as input data into desired Lab information.

FIG. 6C illustrates an edit screen 621 displayed on the operation unit 209 of the server 101. On the edit screen 621, it is allowed to edit an arbitrary spot color selected by a user from spot colors stored as spot color information in the HDD unit 205 of the server 101. On the edit screen 621, CMYK information 622 of the selected spot color, Lab information 623 specified by the spot color, and color samples 624 before and after edited are displayed. After the editing of the spot color by a user is completed, if a test print button 625 is pressed, the test page print screen 611 illustrated in FIG. 6B is displayed on the operation unit 209. On the print screen 611, a test chart for checking the spot color, stored in the HDD unit 205 of the server 101, is selected. On the other hand, in a case where a save button 626 is pressed by a user, the edited spot color is saved in the HDD unit 205 of the server 101.

In the profile editing function and in the spot color editing function, when the screen is in a state in which the print screen 611 is displayed on the operation unit 209 of the server 101, the CPU 207 determines that the server 101 is in the status of “adjustment” and stores the status in the status information storage unit 403.

In the example described above, it is assumed by way of example that the profile edit screen 601, the test page print screen 611, and the spot color edit screen 621 are displayed on the operation unit 209 of the server 101. However, alternatively, they may be displayed on the operation unit 318 of the printing apparatus 102. Still alternatively, the profile edit screen 601, the test page print screen 611, and the spot color edit screen 621 may be displayed as server application screens on an operation unit (not illustrated) of the information processing apparatus 104.

Next, a process of registering sheet information in the sheet information storage unit 401 is described below with reference to a flow chart illustrated in FIG. 5. This process is performed on the server 101 such that the CPU 207 executes a program loaded from the HDD unit 205 into the second memory unit 208. Although in the present embodiment, the process of registering sheet information in the sheet information storage unit 401 is described for a case where the process is performed on the server 101, the process may alternatively be performed on the printing apparatus 102. In the case where the process is performed on the printing apparatus 102, the CPU 302 executes a program loaded from the HDD 308 into the RAM 303. On the other hand, in a case where the information processing apparatus 104 plays a role as a server instead of the server 101, the process described above may be performed on the information processing apparatus 104.

First, in S701, the CPU 207 determines whether a registration screen 801 such as that illustrated in FIG. 8 is called. Note that the registration screen 801 is displayed on the operation unit 209 of the server 101. Sheet property information representing, for example, a name, a size, a basis weight, and a surface property of a sheet, and identification information of the sheet indicating a status are registered in the form of a list.

In a case where it is determined in S701 that the registration screen 801 is called, the processing flow proceeds to S702. On the other hand, in a case where it is determined that the registration screen 801 is not called, the processing flow remains in S701.

In S702, the CPU 207 displays the registration screen 801 on the operation unit 209 of the server 101. The processing flow then proceeds to S703.

In S703, the CPU 207 acquires property information representing a name, a size, a basis weight, and a surface property of a sheet input by a user via a sheet information input screen (not illustrated) on the operation unit 209 of the server 101 and also acquires identification information representing a status. The processing flow then proceeds to S704. Note that sheet information about the name, the size, the basis weight, the surface property, and the status of the sheet may alternatively be imported from an external apparatus such as the information processing apparatus 104, the printing apparatus 102, or the like.

As for a sheet used in image adjustment such as a calibration, for example, a recommended sheet 503 such as that illustrated in FIG. 5A specified by a manufacturer may be used in many cases. In view of the above, when a connection between the server 101 and the printing apparatus 102 via the network 105 is established, a destination information set by the printer engine 301 and stored in the HDD 308 may be acquired and property information associated with the recommended sheet 503 may be imported for use as that for an adjustment sheet. Note that the destination information refers to area-specific information where a product is sold. The product name or the surface property of a used sheet may vary depending on areas, and thus information associated with the recommended sheet 503 described above may vary depending on areas.

In S704, in response to pressing of a register button on a non-illustrated sheet information input screen on the operation unit 209 of the server 101, the CPU 207 registers the sheet property information and the identification information acquired in S703 in the sheet information storage unit 401 allocated in the HDD unit 205 of the server 101.

The details of the sequence of steps of the process of registering sheet information in the sheet information storage unit 401 have been described above. In the case where the process is performed on the printing apparatus 102, the process may be performed in a similar manner to a case where the process is per formed on the server 101 if the units used in the process are read as follows. That is, the CPU 207, the operation unit 209, and the HDD unit 205 used in the process on the server 101 respectively may be read as the CPU 302, the operation unit 318, and the HDD 308 in the process on the printing apparatus 102.

Next, a description is given below with reference to a flow chart illustrated in FIG. 9 as to a process of registering sheet information in the sheet feeding unit information storage unit 402 individually for each sheet feeding unit. This process is performed on the server 101 such that the CPU 207 executes a program loaded from the HDD unit 205 into the second memory unit 208. Although in the present embodiment, the description is given, by way of example, for the case where the process of registering sheet information in the sheet feeding unit information storage unit 402 individually for each sheet feeding unit is performed on the server 101, the process may alternatively be performed on the printing apparatus 102. In the case where the process is performed on the printing apparatus 102, the CPU 302 may execute a program loaded from the HDD 308 into the RAM 303 to achieve the process. On the other hand, in a case where the information processing apparatus 104 plays a role as a server instead of the server 101, the process described above may be performed on the information processing apparatus 104.

First, in S901, the CPU 207 determines whether a sheet feeding unit registration screen 1001 such as that illustrated in FIG. 10 is called. Note that the sheet feeding unit registration screen 1001 is displayed on the operation unit 209 of the server 101. Sheet property information representing, for example, a name, a size, a basis weight, and a surface property of a sheet, and identification information of the sheet indicating a status are registered as candidates in the form of a list individually for each sheet feeding unit.

For example, as illustrated in FIG. 10, sheet information associated with “name: Paper2, size: A3, basis weight: 80 g/m², surface property: plain paper, status: adjustment” is registered as a candidate for both sheet feeding units Tray1 and Tray2. As in this example, it is allowed to register the same sheet information as a candidate in relation to a plurality of sheet feeding units.

In a case where it is determined in S901 that the sheet feeding unit registration screen 1001 is called, the processing flow proceeds to S902. On the other hand, in a case where the answer to S901 is NO, the processing flow remains in S901 until the sheet feeding unit registration screen 1001 is called.

In S902, the CPU 207 displays the sheet feeding unit registration screen 1001 on the operation unit 209 of the server 101. The processing flow then proceeds to S903.

In S903, the CPU 207 acquires information associated with a sheet feeding unit selected by a user on the operation unit 209 of the server 101. The processing flow then proceeds to S904.

In S904, the CPU 207 refers to all sheet information registered in the sheet information storage unit 401 allocated in the HDD unit 205 of the server 101. The processing flow then proceeds to S905.

In S905, the CPU 207 acquires, from the sheet information referred to in S904, the property information and the identification information of a sheet selected by a user. The processing flow then proceeds to S906. The property information of the sheet acquired in S905 represents, for example, the name, the size, the basis weight, and the surface property of the sheet, and the identification information of the sheet is status information. Note that sheet information about the name, the size, the basis weight, the surface property, and the status of the sheet may alternatively be imported from an external apparatus such as the information processing apparatus 104, the printing apparatus 102, or the like.

In S906, in response to pressing of a not-illustrated register button on displayed on the operation unit 209 of the server 101, the CPU 207 registers the sheet property information and the identification information associated with the selected sheet feeding unit, acquired in S905, in the sheet feeding unit information storage unit 402 allocated in the HDD unit 205 of the server 101. The sheet property information registered in the sheet feeding unit information storage unit 402 includes information representing, for example, the name, the size, the basis weight, and the surface property of the sheet, and the identification information of the sheet is status information. A combination of these pieces of property information and identification information of a sheet is stored as a candidate.

The details of the sequence of steps of the process of registering sheet information in the sheet feeding unit information storage unit 402 individually for each sheet feeding unit have been described above. In the case where the process is performed on the printing apparatus 102, the process may be performed in a similar manner to a case where the process is performed on the server 101 if the units used in the process are read as follows. That is, the CPU 207, the operation unit 209, and the HDD unit 205 used in the process on the server 101 respectively may be read as the CPU 302, the operation unit 318, and the HDD 308 in the process on the printing apparatus 102.

In the first embodiment, in response to closing a sheet feeding unit, a sheet is searched for from the sheet feeding unit information storage unit 402 based on the size of sheets held on the closed sheet feeding unit and the status of the server 101 as of when the sheet feeding unit is closed. Based on a result of the search, sheet property information registered in the sheet feeding unit information storage unit 402 is saved so as to be related to the closed sheet feeding unit as described below. In the following description of the operation according to the first embodiment, it is assumed that the sheet information illustrated in FIG. 10 has already registered in the sheet feeding unit information storage unit 402.

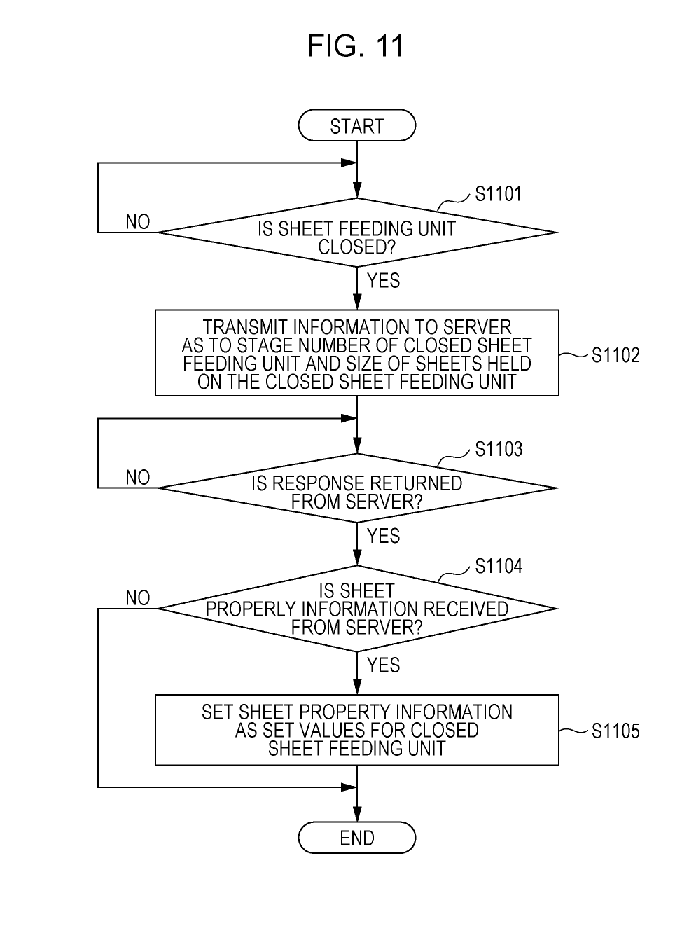

Referring to a flow chart illustrated in FIG. 11, a description is given below as to a sequence of steps of the process performed by the printing apparatus 102 to save property information of a particular sheet in relation to a sheet feeding unit according to the first embodiment. This process is performed on the printing apparatus 102 such that the CPU 302 may execute a program loaded from the HDD 308 into the RAM 303 to achieve the process.

First, in S1101, the CPU 302 determines whether a sheet feeding unit in an open state is closed. Note that in S1101, it is assumed that a sheet feeding unit is opened to put sheets to be used in executing a job and the sheet feeding unit in the open state is closed after the sheets are put thereon.

In a case where it is determined that a sheet feeding unit is closed, the processing flow proceeds to S1102. On the other hand, in a case where the answer to S1101 is NO, the processing flow remains in S1101. Note that closing of a sheet feeding unit from an open state may be detected based on information acquired from the open/close detection sensor 326 illustrated in FIG. 3 or the like.

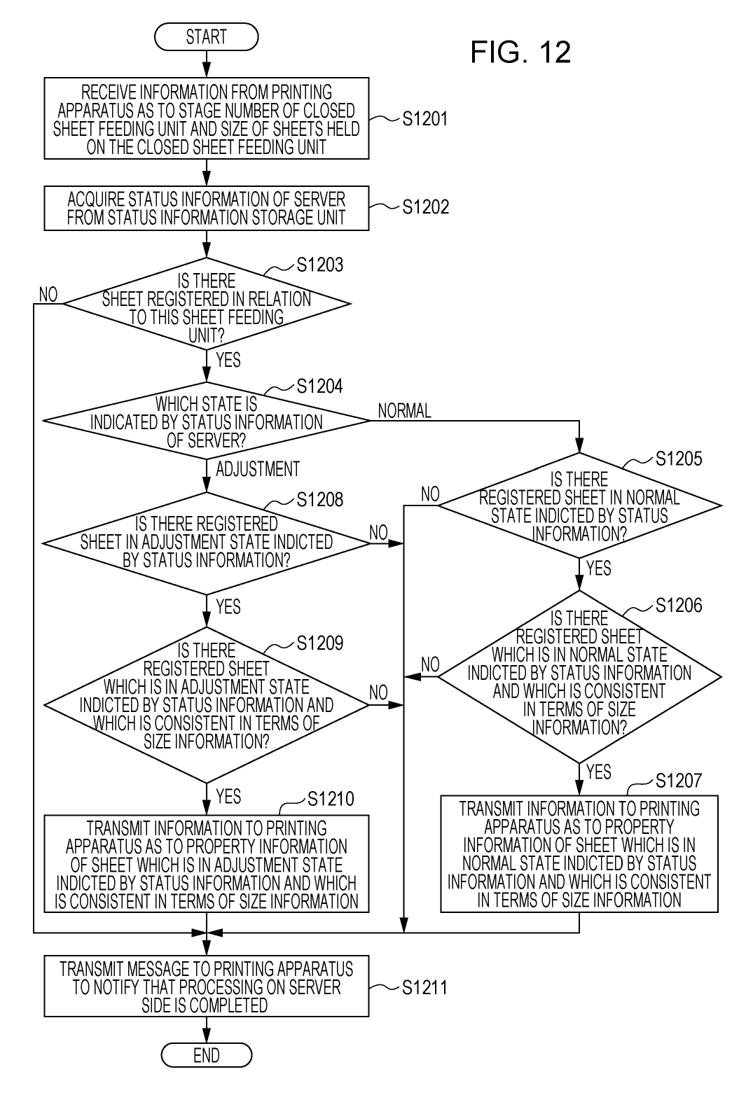

In S1102, the CPU 302 acquires the stage number of the sheet feeding unit determined in S1102 to be closed and also acquires the size of sheets held on this sheet feeding unit determined to be closed, and the CPU 302 transmits information about them to the server 101 via the network 105. Note that information about the size of a sheet held on a sheet feeding unit is necessary in identifying a sheet registered in the sheet feeding unit information storage unit 402. The sheet size can be detected based on information acquired from the size detection sensor 325 illustrated in FIG. 3 or the like. The information transmitted in S1102 from the printing apparatus 102 is received by the server 101 in S1201 as described later with reference to FIG. 12.

The processing flow then proceeds to S1103 in which the CPU 302 determines whether a response from the server 101 is returned via the network 105 after the transmission of the sheet size information in S1102. In a case where it is determined that a response from the server 101 is received, the processing flow proceeds to S1104. On the other hand, in a case where the answer to S1103 is NO, the processing flow remains in S1103. In a case where no response from the server 101 is returned within a predetermined period, time out may occur. In this case, it may be allowed to exit the sequence of steps illustrated in FIG. 11 as to the process of saving the property information for particular sheet as a setting value in relation to a sheet feeding unit. Note that the information received in S1103 by the printing apparatus 102 is responded to by the server 101 in S1211 described below with reference to FIG. 12.

In S1104, the CPU 302 determines whether sheet property information is received from the server 101. In a case where it is determined that sheet property information is received from the server 101, the processing flow proceeds to S1105. In S1105, the CPU 302 saves the sheet property information received in S1104 from the server 101 so as to be related to the sheet feeding unit determined in S1101 as being closed. In a case where the sheet property information received in S1104 from the server 101 includes information of a plurality of sheets, property information of a sheet selected by a user from a plurality of sheet candidates may be set as a setting value for the sheet feeding unit. After the process in S1105 is completed, the sequence of steps of the process of saving property information of a particular sheet in relation to a sheet feeding unit is ended.

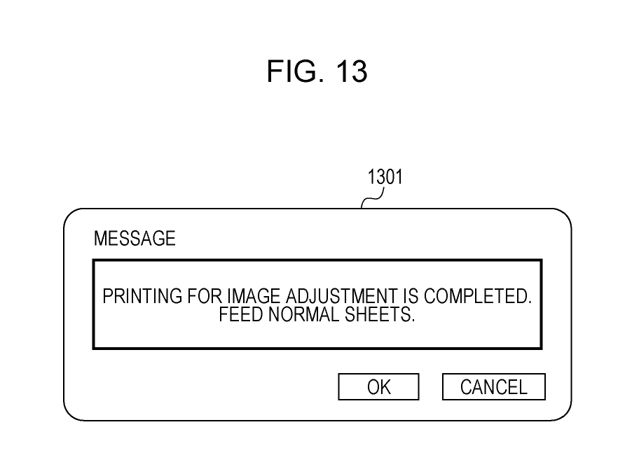

In a case where, in S1105, the sheet property information saved in relation to a sheet feeding unit is changed from property information of a sheet used in “adjustment” to property information of a sheet used in the “normal” state, it is necessary to replace the sheet held on the sheet feeding unit. For example, in a case where a recommended sheet for use in image adjustment printing is held on the sheet feeding unit, it is necessary to replace the sheet with a sheet for use in a normal printing mode. In this case, a warning screen 1301 such as that illustrated in FIG. 13 may be displayed on the operation unit 318 of the printing apparatus 102 to prompt a user to replace the sheet for adjustment with a sheet for normal use. This prevents a sheet for adjustment from being fed without being replaced with a proper sheet.

On the other hand, in a case where the answer to S1104 is NO, the sequence of steps of the process of saving property information of a particular sheet as setting values in relation to a sheet feeding unit is ended. On the other hand, in a case where the answer to S1104 is NO, property information of a default sheet (for example, size: A4, basis weight: 70 g/m², surface property: plain paper) may be saved in relation to the sheet feeding unit and then the process may be ended. Note that the information received in S1104 by the printing apparatus 102 is transmitted by the server 101 in S1207 or S1310 described later with reference to FIG. 12.

Detailed description has been given above as to the sequence of steps of the process performed by the printing apparatus 102 to save property information of a particular sheet so as to be related to a particular sheet feeding unit according to the first embodiment.

In a case where the sheet status information received in S1104 from the server 101 indicates “normal”, and furthermore property information of a sheet used in “adjustment” has already be saved so as to be related to the sheet feeding unit, a process described below may be further performed. That is, in S1105, the sheet property information of the sheet for “normal” use is saved and thereafter a warning such as that illustrated in FIG. 13 may be displayed on the operation unit 318 of the printing apparatus 102. This prompts a user to replace sheets such that a sheet for “normal” use is fed thereby preventing a sheet for adjustment use from being fed.

Next, a description is given below with reference to a flow chart illustrated in FIG. 12 as to a sequence of processes performed in the server 101 to search for sheets registered in the sheet feeding unit information storage unit 402 according to the first embodiment. This process is performed on the server 101 such that the CPU 207 executes a program loaded from the HDD unit 205 into the second memory unit 208. Although in the first embodiment, the description is given, by way of example, for the case where the process of searching for sheets registered in the sheet feeding unit information storage unit 402 is performed on the server 101, the process may alternatively be performed on the printing apparatus 102. In the case where the process is performed on the printing apparatus 102, the CPU 302 executes a program loaded from the HDD 308 into the RAM 303. On the other hand, in a case where the information processing apparatus 104 plays a role as a server instead of the server 101, the process described above may be performed on the information processing apparatus 104.

First, in S1201, the CPU 207 receives information from the printing apparatus 102 via the network 105 as to the stage number of the closed sheet feeding unit and the size information of sheets held on the closed sheet feeding unit. Note that the information received in S1201 by the server 101 is transmitted by the printing apparatus 102 in S1102 in FIG. 11 described above.

The processing flow then proceeds to S1202 in which the CPU 207 acquires status information of the server 101 from the status information storage unit 403 allocated in the HDD unit 205 of the server 101. For example, in a state in which the calibration setting screen 511 is displayed on the operation unit 209 of the server 101, “adjustment” stored as the status information in the status information storage unit 403 is acquired in S1202. Note that although in S1202 the status information of the server 101 is acquired in the above example, the status information of the printing apparatus 102 may alternatively be acquired. For example, in a state in which printing for image adjustment is performed in the printing apparatus 102, the status information “adjustment” is acquired.

The processing flow then proceeds to S1203 in which the CPU 207 identifies the sheet feeding unit based on the information received in S1201 as to the stage number of the closed sheet feeding unit, and the CPU 207 checks the sheet feeding unit information storage unit 402 allocated in the HDD unit 205 of the server 101 to determine whether a sheet is registered in relation to the above sheet feeding unit detected to be closed. In a case where there is a registered sheet related to the closed sheet feeding unit, the processing flow proceeds to S1204. On the other hand, in a case where it is determined that no sheet is registered for this sheet feeding unit, the processing flow proceeds to S1211.

In S1204, the CPU 207 determines whether the status information of the server 101 acquired in S1202 is “normal” or “adjustment”.

In a case where it is determined that the status information is “normal”, the processing flow proceeds to S1205. In S1205, the CPU 207 checks the sheet feeding unit information storage unit 402 allocated in the HDD unit 205 of the server 101 to determine whether a sheet with status information “normal” is registered in relation to the above-described sheet feeding unit detected to be closed.

In a case where it is determined that such a registered sheet is found, the processing flow proceeds to S1206. On the other hand, in a case where it is determined that no such registered sheet is found, the processing flow proceeds to S1211.

In S1206, the CPU 207 checks the sheet feeding unit information storage unit 402 allocated in the HDD unit 205 of the server 101 to determine whether there is a registered sheet which is related to the above-described sheet feeding unit and whose status information is “normal” and whose size information is consistent.

In a case where such a registered sheet is found, the processing flow proceeds to S1207. On the other hand, in a case where it is determined that no such registered sheet is found, the processing flow proceeds to S1211.

In S1207, the CPU 207 determines the property information of the sheet whose status information is “normal” and whose size information is consistent, and transmits the determined property information to the printing apparatus 102. The property information transmitted herein includes information about the size of the sheet, the basis weight of the sheet, the surface property of the sheet and/or the like to be set for the sheet feeding unit. Note that the information transmitted in S1207 by the server 101 is received by the printing apparatus 102 in S1104 in FIG. 11 described above.

In a case where the property information for the sheet feeding unit registered in the sheet feeding unit information storage unit 402 includes property information of a plurality of sheets whose status information is “normal” and whose size information is consistent, property information of a sheet selected by a user may be set for the sheet feeding unit. After the process in S1207 is completed, the processing flow proceeds to S1211.

On the other hand, in a case where it is determined in S1204 that the status information acquired in S1202 is “adjustment”, the processing flow proceeds to S1208.

In S1208, the CPU 207 checks the sheet feeding unit information storage unit 402 allocated in the HDD unit 205 of the server 101 to determine whether a sheet with status information “normal” is registered in relation to the above-described sheet feeding unit.

In a case where it is determined that such a registered sheet is found, the processing flow proceeds to S1208. On the other hand, in a case where it is determined that no such registered sheet is found, the processing flow proceeds to S1211.

In S1209, the CPU 207 checks the sheet feeding unit information storage unit 402 allocated in the HDD unit 205 of the server 101 to determine whether there is a registered sheet which is related to the above-described sheet feeding unit and whose status information is “adjustment” and whose size information is consistent.

In a case where it is determined that such a registered sheet is found, the processing flow proceeds to S1210. On the other hand, in a case where it is determined that no such registered sheet is found, the processing flow proceeds to S1211.

In S1210, the CPU 207 determines the property information of the sheet whose status information is “adjustment” and whose size information is consistent, and transmits the determined property information to the printing apparatus 102. The property information transmitted herein includes information about the size of the sheet, the basis weight of the sheet, the surface property of the sheet and/or the like to be set for the sheet feeding unit. Note that the information transmitted in S1210 by the server 101 is received by the printing apparatus 102 in S1104 in FIG. 11 described above.

In a case where the property information for the sheet feeding unit registered in the sheet feeding unit information storage unit 402 includes property information of a plurality of sheets whose status information is “adjustment” and whose size information is consistent, for example, one sheet may be selected according to the type of a calibration set. Alternatively, one sheet may be selected according to the type of a test chart to be printed. The property information of the selected one sheet may be set so as to be related to the sheet feeding unit. In a case where it is difficult to select one sheet from a plurality of sheet candidates, property information of a sheet selected by a user from the plurality of sheet candidates may be set so as to be related to the sheet feeding unit. After the process in S1210 is completed, the processing flow proceeds to S1211.

In S1211, the CPU 207 sends a message to the printing apparatus 102 via the network 105 to notify that the process on the server 101 is completed. Thereafter, the process of searching for sheets registered in the sheet feeding unit information storage unit 402 allocated in the HDD unit 205 of the server 101 is ended. Note that the information returned in S1211 by the server 101 is received by the printing apparatus 102 in S1103 in FIG. 11 described above.

The description has been given above as to the sequence of processes performed in the server 101 to search for sheets registered in the sheet feeding unit information storage unit 402 according to the first embodiment. In the case where the process is performed on the printing apparatus 102, the process may be performed in a similar manner to a case where the process is performed on the server 101 if the units used in the process are read as follows. That is, the CPU 207 and the HDD unit 205 used in the process on the server 101 respectively may be read as the CPU 302 and the HDD 308 in the process on the printing apparatus 102.

In the first embodiment, as described above, in response to closing a sheet feeding unit, the sheet feeding unit information storage unit 402 is searched based on the size information of a sheet held on the closed sheet feeding unit and the status information of the server 101 or the printing apparatus 102. As a result of the search, a sheet whose size information and status information are consistent is selected and property information thereof is set so as to be related to the sheet feeding unit. As described above, in a situation in which a sheet used in normal printing is different from a sheet used in image adjustment, the setting of a sheet feeding unit may be easily saved depending on the status information of the server 101 or the printing apparatus 102 simply in response to an operation by a user to close the sheet feeding unit. Thus, it is not necessary for a user to input all property information of a sheet each time setting is performed.

In the first embodiment, in the case where, in the search, no sheet whose size information and status information are consistent is found in the sheet feeding unit information storage unit 402, then in S1211 a message is sent to the printing apparatus 102 to inform that the process on the server 101 is ended. Alternatively, in the case where, in the search, no sheet whose size information and status information are consistent is found, property information of all sheets stored in the sheet information storage unit 401 may be transmitted to the printing apparatus 102 and the processing flow may proceeds to a next step. Still alternatively, a message may be transmitted to the printing apparatus 102 to inform that there is no sheet whose size information and status information are consistent, and a message may be displayed on the operation unit 318 to notify a user that there is no sheet whose size information and status information are consistent.

In the first embodiment, the process is described, by way of example, for the case where status information of the server 101 and size information of a sheet held on a closed sheet feeding unit are received from the server 101, and sheet property information related to the sheet feeding unit is set based on the received information, and also for the case where status information of the printing apparatus 102 and size information of a sheet held on a closed sheet feeding unit are received from the printing apparatus 102, and sheet property information related to the sheet feeding unit is set based on the received information. Alternatively, inquiry as to the status of the server 101 may be issued and furthermore size information of a sheet held on a sheet feeding unit may be acquired from the printing apparatus 102. Based on the acquired information, sheet property information related to the sheet feeding unit may be set.

In the first embodiment described above, when closing of a sheet feeding unit in an open state is detected, size information of a sheet held on the sheet feeding unit is transmitted to the server 101, and, based on the size information, the following process is performed. Alternatively, for example, a button may be provided on the operation unit 318 such that size information of a sheet held on a sheet feeding unit is transmitted to the server 101 when this button is pressed. Upon detecting pressing this button, the sheet information of the sheet held on the sheet feeding unit is transmitted to the server 101 and, based on the size information, the following process is performed. In the embodiment described above, a sheet size is detected as one of items of the property information of the sheet held on the sheet feeding unit. Alternatively, a plurality of items of the sheet property information may be detected, and, based on the detected items of the property information, the following process may be performed.

In the embodiment described above, the information sent to the server 101 is as to the size of the sheet held in the sheet feeding unit. However, the information sent is not limited to that. For example, in a case where a sensor is provided on a sheet feeding unit to detect a color of a sheet, and sheet color information is registered in the sheet information storage unit 401 and the sheet feeding unit information storage unit 402, the sheet color information may be transmitted together with the sheet size information to the server 101, and a sheet may be selected based on the color and the size. Alternatively, only sheet color information instead of the sheet size information may be transmitted to the server 101, and a sheet may be selected based only on the sheet color.

Note that the present invention is not limited to the embodiments described above. Various modifications (including combining embodiments) are possible without departing from the scope of the invention.

In the embodiments described above, by way of example, a size is detected as one of items of sheet property information. However, alternatively, a plurality of items of sheet property information may be detected and transmitted, and the following process may be performed based on these items of the sheet property information.

In the embodiments described above, by way of example, the information transmitted to the server 101 is as to the size of a sheet held on a sheet feeding unit. In a case where sensors are provided on the sheet feeding unit to detect a color of a sheet, a basis weight of the sheet, the surface property of the sheet, and/or the like, and the color, the basis weight, the surface property and/or the like of the sheet are registered in the sheet information storage unit 501 and the sheet feeding unit sheet information storage unit 502, then information about the color, the basis weight, the type and/or the like of the sheet may be transmitted together with the size information to the server 101, a sheet may be selected based on the sheet size, the sheet color, the basis weight of the sheet, the surface property of the sheet, and/or the like. Alternatively, only sheet color information instead of the sheet size information may be transmitted to the server 101, and a sheet may be selected based only on the sheet color.

That is, in a case where property information including at least one of the size, the basis weight, the color, and the surface property of the sheet, it is allowed to set sheet property information related to the sheet feeding unit such that the sheet property information include at least one of the above-described items of the property information.

In the embodiments described above, by way of example, the printing apparatus 102 and the external server 101 are connected to each other via the network 105. Alternatively, the printing apparatus 102 and a printing control apparatus disposed in the printing apparatus 102 and functioning as a server may perform part or all of the control processes described above. Alternatively, part or all of the control processes described above may be performed only by the printing apparatus 102 without performing the process by the server 101 functioning as a printing control apparatus. That is, the server 101 functioning as the printing control apparatus may be disposed in the printing apparatus 102 or the information processing apparatus 104. Alternatively, the printing apparatus 102 may be connected to a plurality of information processing apparatuses 104 via the network 103 such as a LAN, a WAN, or a wireless LAN thereby making it possible to perform part or all of the control processes described above.

While the present invention has been described with reference to various embodiments and examples, the scope of the invention is not limited to particular descriptions given above.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-184056 filed Sep. 5, 2013 which is hereby incorporated by reference herein in its entirety.

What is claimed is:

1. A printing apparatus comprising:
a storing unit configured to store a size of a sheet used in printing for image adjustment by a printing unit of the printing apparatus and property information of the sheet, and also store a size of a sheet not used in printing for image adjustment by the printing unit and property information of the sheet not used in printing;
an obtaining unit configured to obtain a size of a sheet held in a sheet holding unit;
a determining unit configured to determine whether the printing apparatus is in a state in which it is allowed to perform the printing for the image adjustment by the printing unit; and
a setting unit configured to set sheet property information such that, in a case where the determining unit determines that the printing apparatus is in the state in which it is allowed to perform the printing for the image adjustment, the setting unit reads out, from the storing unit, the property information of the sheet that is used in the printing for the image adjustment and that has a size consistent with the size obtained by the obtaining unit, and the setting unit sets the read property information as property information of the sheet held in the sheet holding unit.

2. A printing apparatus according to claim 1, wherein
the storing unit further stores identification information, for each sheet, for identifying whether the sheet is a sheet used in the printing for the image adjustment.

3. A printing apparatus according to claim 1, further comprising
a detection unit configure to detect closing of the sheet holding unit,
wherein the obtaining unit acquires the property information in accordance with detecting by the detection unit.

4. A printing apparatus according to claim 1, wherein
the printing for the image adjustment is printing for adjustment in terms of at least one of a calibration, a profile adjustment, and a spot color adjustment.

5. A printing apparatus according to claim 1, wherein
the property information represents a property includes at least one of a size of a sheet, a basis weight of the sheet, a color of the sheet, and a surface property of the sheet.

6. A printing control apparatus comprising:
a storing unit configured to store a size of a sheet used in printing for image adjustment by a printing apparatus and property information of the sheet, and also store a size of a sheet not used in printing for image adjustment by the printing apparatus and property information of the sheet not used in printing;
a receiving unit configured to receive, from the printing apparatus, information indicating a size of a sheet held in a sheet holding unit of the printing apparatus;
a determining unit configured to determine whether the printing control apparatus is in a state in which it is allowed to control the printing apparatus to perform the printing for the image adjustment; and
a sending unit configured to send sheet property information such that, in a case where the determining unit determines that the printing control apparatus is in the state in which it is allowed to control the printing apparatus to perform the printing for the image adjustment, the sending unit reads out, from the storing unit, the property information of the sheet that is used in the printing for the image adjustment and that has a size consistent with the size indicated by the information received by the receiving unit, and the sending unit sends the read property information to the printing apparatus.

7. A control method for a printing apparatus having a storing unit configured to store a size of a sheet used in printing for image adjustment by the printing apparatus and property information of the sheet, and also store a size of a sheet not used in printing for image adjustment by the printing apparatus and property information of the sheet not used in printing, the control method comprising:
obtaining a size of a sheet held in a sheet holding unit;
determining whether the printing apparatus is in a state in which it is allowed to perform the printing for the image adjustment; and
setting sheet property information such that, in a case where it is determined that the printing apparatus is in the state in which it is allowed to perform the printing for the image adjustment, setting includes reading out, from the storing unit, the property information of the sheet that is used in the printing for the image adjustment and that has a size consistent with the obtained size, and setting includes setting the read property information as property information of the sheet held in the sheet holding unit.

8. A computer readable storage medium storing a computer program to cause a printing apparatus to perform a control method, wherein the printing apparatus includes a storing unit configured to store a size of a sheet used in printing for image adjustment by the printing apparatus and property information of the sheet, and also store a size of a sheet not used in printing for image adjustment by the printing apparatus and property information of the sheet not used in printing, the control method comprising:
obtaining a size of a sheet held in a sheet holding unit;
determining whether the printing apparatus is in a state in which it is allowed to perform the printing for the image adjustment; and
setting sheet property information such that, in a case where it is determined that the printing apparatus is in the state in which it is allowed to perform the printing for the image adjustment, setting includes reading out, from the storing unit, the property information of the sheet that is used in the printing for the image adjustment and that has a size consistent with the obtained size, and setting includes setting the read property information as property information of the sheet held in the sheet holding unit.
